(19) United States
(12) Patent Application Publication
(10) Pub. No.: US 2003/0046094 A1
(43) Pub. Date: Mar. 6, 2003

(54) Method using telecommunications device to make payments via an automatic electronic funds transfer network

(76) Inventors: Manmeet Singh, Houston, TX (US); Robert L. Earthman JR., Houston, TX (US)

Correspondence Address: Attn: Robert C. Curfiss, BRACEWELL & PATTERSON, L.L.P., P.O. Box 61389, Houston, TX, 77208-1389, US

(21) Appl. No.: 09/941,822

(22) Filed: Aug. 29, 2001

(51) Int. Cl. G06F 17/60

(52) U.S. Cl. 705/1

(57) ABSTRACT

Standard telecommunications devices are used to initiate and complete transfer of funds from a purchaser account to a vendor or seller account. The device is a standard device not dedicated to the payment system. The customer will initially set up an account by accessing a specified telephone number and registering as a user. This permits the customer to then complete any financial transaction with other registered users by using the keypad input function on the device to enter the details of a transaction, the information being electronically transmitted to a central management system. The central management system will then communicate the transaction to the customer's chosen financial institution as an “on-line” transaction. The transaction is completed and funds are transferred to the central management system. The central management system then automatically transfers the funds to the account of a member vendor. The central management system communicates with the member's financial institution as a surrogate ATM. Senders and recipients are provided with a full audit trail of the transaction and can receive an account log of all transactions from the central service center, via Internet, other electronic communications or even mail, if desired.

### BACKGROUND OF THE INVENTION

1. Field of the Invention

The subject invention is generally related to electronic funds transfer and is specifically directed to a method for utilizing standard telecommunications devices to initiate and complete transfer of funds from a purchaser account to a vendor or seller account.

2. Description of the Prior Art

Automatic teller machines (ATMs) have come into widespread use over the last twenty years. In addition to being able to access cash accounts for cash withdrawals, ATMs are now used for many financial transactions, including utility payments, deposits, transfer of funds between accounts, balance inquiries, cash advances from credit accounts, loan payments and the like. Many ATM cards and accounts are also debit cards and may be used to conduct retail sale transactions at retail points-of-sale. More recently, the “check card” has become available, permitting the debit card to be used in the same manner as well-known bankcards such as, by way of example, MasterCard® and Visa® bank credit cards. This permits the user to use the card in the same manner as a credit card for accessing a cash account at the appropriate financial institution in order to complete a transaction at the point-of-sale.

More recently, the Internet has further expanded the ability of the general public to complete financial transactions from a location that is remote from the financial institution. On-line banking is rapidly expanding the ability to pay bills, access financial accounts, transfer funds and make purchases from the convenience of a personal computer. There is no doubt that this activity will continue to expand in the future.

There is one major drawback to each of the currently available systems. Specifically, in order to achieve the highest level of security in completing the various electronic transactions dedicated equipment is required, e.g., an ATM machine, a personal computer with appropriate software, or a point-of-sale reader.

While certain transactions can be completed over the telephone, for example, verbally giving the account information, or using touch tone data entry, the transaction is neither secure nor instantaneous. That is, the purchaser must give all of the account information, including any security code, to the vendor and the vendor does not have instantaneous access and transfer of funds from the purchaser's account to the vendor account. Therefore, there is increased risk to both the purchaser and the vendor when there are non-automated steps inserted into the electronic transfer process, as is common today.

The lack of security makes high risk certain types of transactions over common telephone lines, such as, by way of example, stock trading, purchase of event tickets, lottery tickets and the like. In order to function adequately, such systems require security features limiting the remote transaction capability. Use of dedicated hardware systems or personal computer with dedicated software to emulate the dedicated hardware security features and make common access virtually impossible.

As has been stated by Alan Greenspan, as recently as April 2000: “The payment systems of the United States present a paradox. Our systems and banking arrangements for handling large-value dollar payments are all electronic and have been for many years. Banking records, including those for loans and deposits have been computerized since the 1960s. Securities markets also now rely on highly automated records and systems, born out of necessity following the paperwork crises of the 1970s. Yet in transactions initiated by consumers, paper (currency and checks) remains the payment system of choice.” This is largely because large dollar volume transactions justify the cost of dedicated equipment whereas “routine” transactions do not.

In the United States alone, the payments business represents a $115 billion market for financial institutions, technology vendors and third-party service providers. As recently as 1998 most point-of-sale payments were made with paper. This is particularly true for low-value, high-volume or high frequency payments such as for groceries, dry-cleaning, fast food meal purchases and the like. Continued use of paper (either cash or checks) is resource intensive, particularly when compared to electronic payments. The paper collection system requires the movement of the paper from the consumer to the vendor and then from the vendor to a financial institution in order to receive credit for the transaction, and in the case of checks, from the vendor's financial institution to the purchaser's financial institution in order to debit the purchaser's account. In addition to the resources required to move paper, the time delay in completing the transaction adds up to billions of dollars over the course of a year.

With all of these negatives, paper still remains a preferred method of conducting business largely because it continues to be easy to use, has perceived security, and is generally acceptable for all transactions. Until the “ease of use”, “security” and “acceptability” issues are resolved, the move from paper to electronic transactions will continue to be slow.

Another major factor inhibiting the delay of the movement to electronic versus paper transactions is the allocation of costs throughout the transaction. When cash is used, the purchaser does not pay a transaction fee and the vendor does not pay a transaction fee. By way of contrast, when a credit card is used the vendor always pays a transaction fee and when a debit card is used both the vendor and the purchaser often pay a transaction fee. For obvious reasons, financial institutions encourage such transfers over cash and for equally obvious reasons, purchasers and vendors resist such transfers. This is primarily due to the fact the point-of-sale transactions are considered by financial institutions to be “off-line” transactions, where it is permissible and acceptable for the financial institution to charge a fee. This is to be contrasted “on-line” transactions where the financial institution is directly involved in the transaction and fees are either lower, waived, or do not exist because of competitive conditions. Specifically, if a customer is directly accessing an account at a financial institution (i.e., “on-line”) the fee is lower than if the customer is using account access information to permit a vendor to complete a transaction on behalf to the customer by accessing the customer account information (i.e., “off-line). The exception to this is the debit-card transaction, where the fees charged to the vendor are more consistent with the financial institution's “on-line” fee structure. Until this is resolved, vendors will continue to favor paper transactions over electronic transactions regardless of the convenience and security afforded by electronic transactions.

Thus, there remains a void to fill to encourage and accelerate the movement from paper to electronic payment activity by providing technology that works anywhere, any time, without the requirement of specialized equipment or software, while at the same time not penalizing customers or vendors for using the electronic financial transaction systems set up and controlled by financial institutions.

### SUMMARY OF THE INVENTION

The subject invention is directed to a person-to-person or customer-to-vendor electronic payment system. The system may utilize both hard-wired or wireless telecommunications technology and is accessible and useable anywhere in the world where a telephone or similar telecommunications device is available. It is also functional with widely popular portable telecommunication devices such as, by way of example, Palm Pilot® and Blackberry® PDA's and the like. Using the methodology of the subject invention, the telecommunications device becomes as financially functional as a pocket of cash and is even more convenient than checks or other forms of paper, providing instant secured access to the customer's account while at the same time assuring the availability of and initiating immediate transfer of funds in the customer account to a vendor account at the point-of-sale. This is immensely useful for the great majority of small cash, high frequency transactions such as, by way of example, personal transactions between non-commercial participants, payment for fast-food orders, haircuts, dry cleaning and various other routine, low cash transactions. In addition, it is fully functional for all other transactions currently accomplished using paper, credit card and debit card systems and on-line transfers as well. In summary, the method of the subject invention may be used as a substitute for or a replacement for all commercial transactions. All that is required is that the customer has access to a telecommunications device. By way of example, a user will be able to conduct any financial transaction anywhere in the world as long as the user has a mobile telephone or other PDA with him.

It is an important feature of the subject invention that a high level of security is maintained. The system is virtually theft-proof, leaves a complete audit trail and is easy to use. There is not any requirement for the customer to acquire special hardware or software. The system of the subject invention provides numerous benefits to the consumer/customer, including: convenience, elimination of cash, timeliness, security (nothing can be lost or stolen) and full reporting of even mundane transactions. There are also numerous benefits to the vendor, including: avoidance of transaction fees, confirmation of funds availability, immediate payment (no float), minimization of fraudulent transactions, security of premises (minimum cash or commercial paper on hand) and no terminal acquisition or maintenance fees.

In the preferred embodiment of the subject invention the consumer/customer will have a mobile telephone, PDA or similar portable telecommunications device. This device is a standard device and is not dedicated to the payment system of the subject invention. The customer will initially set up an account by accessing (dialing) a specified telephone number and registering as a user. This will permit the customer to then complete any financial transaction with other registered users. In order to complete a transaction, the customer will use the keypad input function on the device to enter the details of a transaction. This information will be electronically transmitted to a central management system. The central management system will then communicate the transaction to the customer's chosen financial institution as an “on-line” transaction. The transaction is completed and funds are transferred to the central management system. The central management system then automatically transfers the funds to the account of a member vendor. One advantage to this system is that any party can become a member at any time and once registered, transactions can be made between any class of registered members. As an example, a customer member could pay a baby-sitter member using this system.

The subject invention permits both parties of a transaction to transact business by utilizing the in-place ATM network system. In the preferred embodiment of the invention, the central service center of the system of the subject invention communicates with the member's financial institution as a surrogate ATM. Specifically, the customer accesses the system to make a payment to a member vendor. The system then makes an ATM “cash” withdrawal from the customer's account at a customer selected financial institution. The system then makes an ATM “cash” deposit to the member vendor's account at the vendor's selected financial institution. Both financial institutions treat the transaction as an “on-line” cash transaction. Both parties then receive near instantaneous confirmation of the transaction, i.e., an electronically generated receipt.

It is an important aspect of the invention that all members, whether primarily as customers, primarily as vendors or operating in both capacities, have a full audit trail of the transaction and can receive an account log of all transactions from the central service center, via Internet, other electronic communications or even mail, if desired.

In other aspects of the invention, customized members may be identified. For example, a state lottery commission may have a dedicated account for receiving payments for the purchase of lottery tickets. The customer would access the system in the same way to initiate purchase of a lottery ticket. However, additional steps would be put in place to assure the high level of security required that would permit the lottery commission to print or electronically communicate proof of purchase and, where desired, lottery numbers selected by the customer. In many of the popular instant games, the “scratch-and-win” tickets can be replaced with electronically generated random numbers giving a customer instant indication of a win or a loss. In addition, upon receipt of confirmation of an instant win, the system of the subject invention supports immediate electronic transfer of the customer's winnings into the customer's member account.

The system also accommodates tax payments and refunds and other governmental transactions.

The heart of the system of the subject invention is the interface between the customer/vendor/member and the financial institution. This interface receives member information, converts it to an artificial “cash” withdrawal ATM communication with the member's financial institution, receives confirmation of the “cash” transaction from the financial institution and then transfers an artificial “cash” deposit ATM communication to the vendor member's selected financial institution. The financial institution “sees” an on-line ATM. The customer and vendor treat the transaction as a typical point-of-sale transaction.

Specifically, the system of the subject invention is a communications layer interposed between a customer and a vendor for accessing the ATM switch of the customer's and vendor's respective financial institutions without requiring dedicated hardware or software on the part of either the customer or the vendor and without requiring access to the Internet. Moreover, the source of the transaction is invisible to the involved financial institutions, the transaction being treated as an on-line ATM transaction. This is important because it qualifies the transaction for the lowest fee structure available on current financial transaction networks.

It is, therefore, an object and feature of the subject invention to provide a method for conducting electronic financial transactions using standard, readily available hardware devices without any dedicate software provided on the device.

It is also an object and feature of the subject invention to provide a method for conducting off-line electronic financial transactions via the ATM network while treating the transaction as an on-line transaction.

It is a further object and feature of the subject invention to provide a method for completing routine, typical cash transactions via electronic transfer.

It is an additional object and feature of the subject invention to provide a secure system for electronic transfer of funds using common hardware devices without requiring additional, dedicated software.

Other objects and features of the subject invention will be readily apparent from the accompanying drawings and detailed description of the preferred embodiment.

### BRIEF DESCRIPTION OF THE DRAWINGS

FIG. 1 is an illustration of the system architecture.

FIG. 2 is an overview of the system of the subject invention.

FIG. 3 is a flow diagram of the registration process for setting up an account in the system of the subject invention.

FIG. 4 is a flow diagram of a typical transaction using the system of the subject invention.

FIG. 5 is a detailed programming chart of the preferred embodiment of the subject invention.

### DETAILED DESCRIPTION OF THE PREFERRED EMBODIMENT

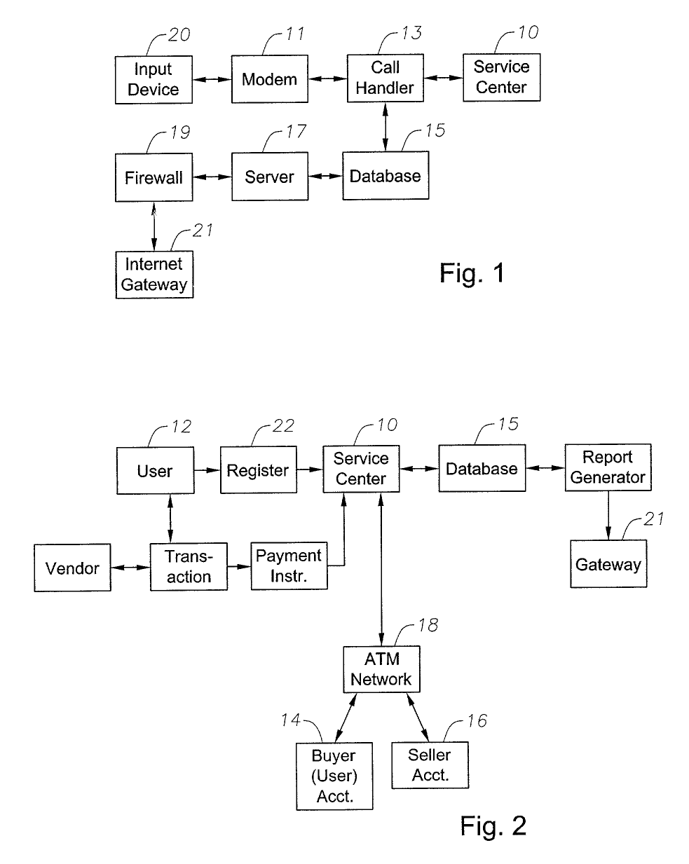

The system architecture is shown in FIG. 1. In the preferred embodiment a central service center 10 is connected to a typical customer/member input device such as the cellular telephone system 20. In the preferred embodiment, the member will access a dial-up modem 11 for communicating with a call handler 13 to communicate with the central service center 10. The central service center will then be able to access the customer database 15 in order to communicate with the member via the telephone 20 and complete the desired transactions. Auditing and report functions are available to the customer by various output devices such the gateway server 17, with appropriate firewalls 19, via the Internet 21. Other audit and report access systems may be used as well, such as periodic hardcopy mailing and the like.

As shown in FIG. 2, the central service center 10 communicates with members 12 via public communication lines (cellular or POTS lines or a combination) and with various financial institutions 14, 16 via the ATM network 18. In the preferred embodiment of the invention, the customer's communication device of choice is a cellular telephone 20. However, any standard telecommunication device may be used. For non-telephonic devices a “touch-tone” simulator will be required in order to communicate with the central server. Of course, other communication devices and signals may be substituted without departing from the scope and intent of the invention, within the skill of those familiar with the art of the subject invention. Touch-tone signal and cellular telephones are preferred because of their widespread availability.

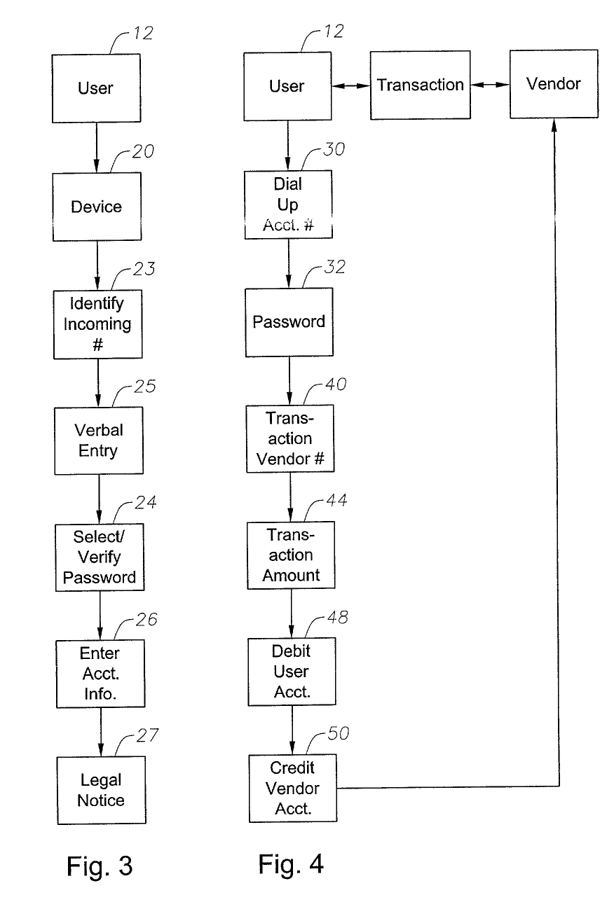

In a typical application, the member 12 will first set up an account with the system by registering as indicated in block 22. This is required whether the member is a member/customer, a member/vendor or both a customer and a vendor. However, only one registration is required to operate in any capacity. In the preferred embodiment and as shown in FIG. 3, the prospective member will access the central service center 10 via a standard telephone number. An automated system will guide the member through the registration process, with the member responding by entering information via the keypad on his telephone. In the preferred embodiment of the system the service center automatically identifies the telephone number as an account number 23 from which the member is calling. Since the telephone number will not be recognized for a prospective member, the system will then default to the registration sequence and instruct the prospective member to select and confirm a password 24. In the preferred embodiment a secondary identification system is also used such as, by way of example, voice recognition 25. The member then enters a debit transaction card number 26 and where desired or required, a pin number. This provides the system with both the financial institution information and account information. Once this information is confirmed, recorded required legal notices and disclaimers 27 are played back to the customer over the telephone line. Once registered, the customer then is only required to dial the service center telephone. The system will recognize his incoming number and prompt the customer to enter his password. Upon confirmation of the password, the transaction may be initiated. In the event the incoming telephone number is not recognized, and as shown in FIG. 3, then the customer may be prompted to manually enter the telephone number before his password is accepted. This also permits the customer use a secondary input device in addition to the registered cellular telephone.

A typical transaction sequence is shown in FIG. 4. A registered member 12 may conduct the purchase of a previously standard cash transaction, such as, by way of example, an oil change. The member will dial the universal access number on his cellular telephone 20 as indicated in block 30. The system will identify his number and request password confirmation and, where desired, secondary confirmation such as voice recognition or the like. Once confirmed, the member is authorized to complete the transaction as shown in block 40. The member then enters the vendor/member number, typically the vendor telephone number and for additional security a transaction identification code. The member will then be prompted to enter a transaction amount as shown in block 44. This will be confirmed and the transaction will be completed. At this point the system will access the member's registered account at a financial institution via the ATM network and debit the account, as indicated at block 48 and will the transfer the debited amount to the vendor's account via the ATM network as indicated in block 50. A verbal confirmation will be provided to the member/customer via the telephone. An electronic confirmation will also be provided to the vendor, via pager, Internet or via telephone. A transaction log is sent to both member data base and a report of relevant transactions can be downloaded by either the member/customer or the member/vendor at any time or automatically sent electronically or by other means on a periodic basis.

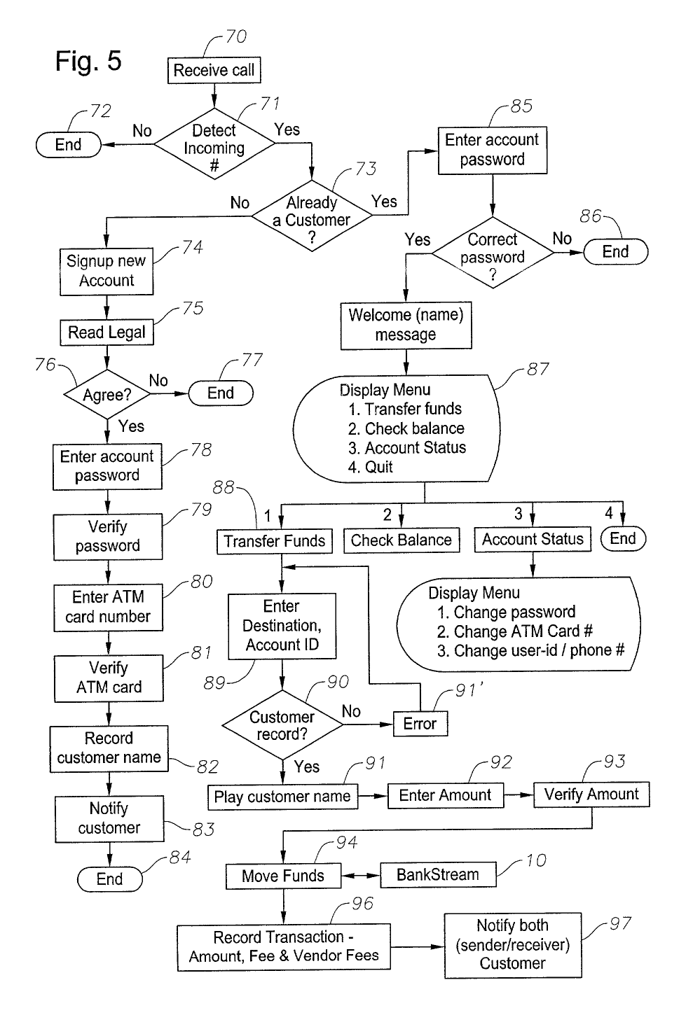

A detailed programming chart of the system of the preferred embodiment is shown in FIG. 5. As there shown, the service center will receive an incoming call at 70 and check to determine if the entire number is identified 71. If not the call is terminated at 72. If YES, then the database is accessed to determine whether the call identifies a registered member at 73. If NO, then the registration process is initiated at 74. The legal notices and disclaimers are given at 75 and accepted or rejected at 76. If rejected the call is terminated at 77. If accepted the new member is prompted to select and enter a password at 78 and confirm the password at 79. The new member is then prompted to enter the ATM card number and PIN at 80 and confirm this at 81. The member's name is then orally entered and recorded at 82 and the member is notified that his account is registered at 83. The registration sequence is then complete as indicated at 84.

Returning to the customer confirmation block 73, if the database confirms that the incoming call indicates the caller is a registered member, the member is prompted to enter his password at 85. If incorrect the call is terminated at 86. If correct, the member is prompted to select various functions at 87. If the transfer finds function is selected as indicated at 88, the member is prompted to enter the payee or destination account identification code at 89. The code is verified at 90. If the code cannot be verified the member is informed of an error at 91 and the sequence is restarted. Once the code is confirmed, the member is given a verbal identification of the customer (using the recording made in the registration process, see step 82). The amount of the transaction is then entered via the telephone keypad, see 92. This is verified at 93 and the fund transfer sequence begins at 94 by using the service center link as indicated at 10 to communicate with the relative financial institutions via the ATM network as previously described. A transaction record is generated and recorded in the database at 96 and both the sender and receiver are notified as shown at 97.

The system can accommodate debit cards, bankcards, major credit cards or straight account transfers not tied to card technology. That is, the member can select the account and the identifiers for accessing the account during the registration process. Once registered repeated telephone transactions may be made simply using the incoming telephone number and password as the identifiers for initiating the transaction. Where desired, secondary recognition systems may be employed for added layers of security, such as by way of example, voice recognition. The system may charge a fee per transaction by either adding a fee to the sender's transaction amount or by discounting the payment to the receiver's account. Numerous input devices may be used such as, by way of example, pagers, personal computers, POTS telephones, as well as the preferred cellular telephone. The crux of the invention is that the input device is standard, common hardware, greatly expanding the availability of the system to the consumer.

It is an important feature of the subject invention that the registered user never has to input his ATM or other card or account number and PIN number once registered. This provides an added layer of security against theft since a thief could only access his accounts by using the registered cellular telephone as an input device. If a card is stolen it can be used at many dedicated terminals. Using the system of the subject invention, the card is not required to be carried.

The enhanced security features of the subject invention lend to use of the transaction system for various high-security transactions such as lottery sales and the like. In fact, in one aspect of the invention, instant win game tickets can be replaced with a completely electronic game. In this embodiment, the vendor/member, generally an authorized lottery commission or licensee, would incorporate a random number generator into the system. When the member/customer desires to “play” he would access the system as before by dialing in and using his password. He would then enter the lottery identification number, which may include selecting a game. For example, he may select an “instant win” game, where a certain number sequence would guarantee a win. He then would be prompted to pay for the desired number of tickets and the random number generator would indicate whether he won. If he wins, the lottery commission would then become the sender and transmit the appropriate winnings to the player's account. He could also select a series of numbers and the random number generator would determine whether he selected a match. Again, if he wins, the funds would be automatically transferred into his registered account.

It is not the intent of this invention to resolve all of the legal issues involved in electronic gaming and interstate gaming laws. The purpose of this disclosure is to demonstrate the feasibility of the technology, greatly expanding the opportunity for legal lottery commissions to reach the market without requiring the player to go to specific licensed vendors and minimizing the high cost of printing secure tickets for such games. In fact, it is anticipated that one aspect of the invention would be to place the electronic game system at licensed or vendor cite in order to eliminate the vendor's requirement to inventory tickets and handle cash associated with lottery sales. This eliminates theft and reduces risk to the vendor. In addition, it would permit the lottery commission to immediately credit the selling vendor's account for sales and winning player accounts with winnings.

The system of the subject invention provides a convenient method for conducting electronic funds transfer using common, readily available telecommunications hardware for myriad transactions and is particularly useful for promoting electronic funds transfer in heretofore paper intensive transactions. While certain features and embodiments of the invention have been described in detail herein, it should be readily understood that the invention includes all modifications and enhancements within the scope and spirit of the following claims.

What is claimed is:

1. A method for conducting a financial transaction of a registered user using a common telecommunications device over a communication network, comprising the steps of
a. entifying an incoming message by an identifier assigned to the device from which the incoming message is transmitted;
b. verifying the device as a registered user device based on the identifier;
c. receiving payment instructions to a third party from the registered user device;
d. contacting a financial institution selected by the registered user device to electronically transfer funds to a financial institution selected by the third party.

2. A method for conducting a financial transaction of a registered user using a common telecommunications device over a telephonic network, comprising the steps of:
a. identifying an incoming telephone call by the telephone number assigned to the device from which the incoming call is made;
b. verifying the device as a registered user device based on the identified telephone number;
c. receiving payment instructions to a third party from the registered user device;
d. contacting a financial institution selected by the registered user device to electronically transfer funds to a financial institution selected by the third party.

3. The method of claim 2, wherein the verifying step includes assigning and confirming a password entered by the registered user.

4. The method of claim 2, wherein the contacting step comprises contacting each of said financial institutions via the ATM system network.

5. The method of claim 4, wherein the electronic transfer of funds in on-line.

6. The method of claim 2, including the additional step of confirming the transfer of funds to the third party.

7. The method of claim 2, including the additional step of confirming the transfer of funds to the registered user.

8. The method of claim 2, further including the step of logging the transfer of funds.

9. The method of claim 8, further including the step of generating a report for the end user showing all fund transfers on the behalf of the registered user.

10. The method of claim 9, further including the step of providing the report online line to the registered user.

11. The method of claim 8, further including the step of generating a report for the third party user showing all find transfers on the behalf of the registered user.

12. The method of claim 11, further including the step of providing the report online line to the third party.

13. The method of claim 2, further including the step of overriding the incoming telephone number identifier by a manually entered number recognizable as an alternative identified number in the verifying step.

14. The method of claim 2, the verifying step further including the step of confirming the registered user by voice.

15. The method of claim 2, including an initial step of registering a user as a registered user.

16. The method of claim 2, wherein the financial institution and related account of the registered user is identified by an account number supplied by the registered user.

17. The method of claim 16, wherein the account number is a debit card number for accessing the registered user account via an ATM system network.

18. The method of claim 16, further including the step of the registered user supplying the PIN number assigned to the debit card.

19. The method of claim 15, wherein the registering step includes the sub-steps of:
a. identifying the telephone number assigned to the incoming device;
b. prompting the user to select a password;
c. confirming the password;
d. identifying a selected financial institution account by entering a related account number.

20. The method of claim 19, further including the step of informing the user of legal notices and disclaimers prior to the identification of an account.

21. The method of claim 20, further including the step of terminating the registration process upon completion of the informing step.

22. The method of claim 19, further including the step of prompting the user to provide a voice identification after selection of the password.

23. The method of claim 2, wherein the common telecommunications device is a cellular phone.

24. The method of claim 2, wherein the common telecommunications device is a PDA having dial-up capability over a telephonic network.

25. The method of claim 2, wherein both the third party is also a registered user.

26. A method for completing payment of a financial transaction by electronically transferring funds from a user account to a vendor account using a remote input device, comprising the steps of:
a. identifying an incoming message call by an identifier assigned to the remote device from which the incoming message is transmitted;
b. verifying the device phone user as a registered user based on the identifier;
c. assigning a unique password to the user and verifying the password prior to the completion of any additional steps;
d. identifying a selected financial institution account by entering a related account number.
e. receiving payment instructions to a third party from the registered user;
f. contacting a financial institution selected by the registered user to electronically transfer funds to a financial institution selected by the third party.

27. A method for completing payment of a financial transaction by electronically transferring funds from a user account to a vendor account using a cellular phone, comprising the steps of:
a. a identifying an incoming telephone call by the telephone number assigned to the cellular phone from which the incoming call is made;
b. identifying the telephone number assigned to the incoming device
c. verifying the cellular phone user as a registered user based on the identified telephone number;
d. assigning a unique password to the user and verifying the password prior to the completion of any additional steps;
e. identifying a selected financial institution account by entering a related account number.
f. receiving payment instructions to a third party from the registered user;
g. contacting a financial institution selected by the registered user to electronically transfer funds to a financial institution selected by the third party.

28. The method of claim 27, wherein the account number is a debit card number for accessing the registered user account via an ATM system network.

29. The method of claim 28, further including the step of the registered user supplying the PIN number assigned to the debit card.

30. A method for purchasing an electronic lottery game from and authorized lottery commission via a common communication device, comprising the steps of:
a. identifying an incoming message call by an identifier assigned to the device from which the incoming message is transmitted;
b. identifying the identifier assigned to the incoming device;
c. verifying the device user as a registered user based on the identifier;
d. assigning a unique password to the user and verifying the password prior to the completion of any additional steps;
e. identifying a selected financial institution account by entering a related account number.
f. receiving an order to purchase a game from the registered user;
g. contacting a financial institution selected by the registered user to electronically transfer funds to cover the cost of the game to an authorized recipient of funds for the lottery commission;
h. activating the game purchased by the user;
i. informing the user of the outcome of the game over the device;
j. electronically transferring any winnings from a financial account of the lottery commission to the selected financial account of the user.

31. The method of claim 30, wherein the incoming device is a cellular telephone.

32. The method of claim 30, wherein the game includes a random number generator and wherein a certain sequence of numbers identifies a win.

33. The method of claim 30, wherein the customer may select a sequence of numbers to match by entering the number sequence via a key pad on the device.

34. The method of claim 30, wherein the electronic funds transfer is made via an ATM system network.

35. The method of claim 30, wherein the account number entered by the user is an ATM account number and PIN.

36. The method of claim 30, wherein the device is a dedicated device at an authorized licensee of the lottery commission.

37. The method of claim 30, wherein the device is a cell phone assigned to the user.
